(19) United States
(12) Patent Application Publication
(10) Pub. No.: US 2023/0385561 A1
(43) Pub. Date: Nov. 30, 2023

(54) DATA DRIVEN TRANSLATION AND TRANSLATION VALIDATION OF DIGITAL CONTENT

(71) Applicant: Jitterbit, Inc., Alameda, CA (US)

(72) Inventor: Thomas R. Kennedy, Jr., Miami Beach, FL (US)

(21) Appl. No.: 18/323,446

(22) Filed: May 25, 2023

Related U.S. Application Data
(60) Provisional application No. 63/346,047, filed on May 26, 2022.

(51) Int. Cl. G06F 40/58; G06F 40/51

(52) U.S. Cl. CPC G06F 40/58; G06F 40/51

(57) ABSTRACT

Systems and devices are configured for receiving a translation query specifying a text string, a target language for translating the text string, and an original language of the text string; generating, based on inputting the text string into translation logic of a translation service, first translation data comprising a translated text string in the target language; inputting, into the translation logic, the first translation data comprising the translated text string in the target language; generating, based on inputting, second translation data representing translation of the translated text string to the original language from the target language; comparing the second translation data to the translation query; when the translation of the translated text string to the original language from the target language matches the text string of the translation query, validating the first translation data; and outputting, in response to validating, the first translation data.

### RELATED MATTERS

This application claims the benefit of U.S. Provisional Patent Application No. 63/346,047, filed May 26, 2022, the contents of which are incorporated herein by reference in their entirety.

### TECHNICAL FIELD

This document describes systems and methods for data translation, validation, and representation. More specifically, this document describes services and interfaces for automatic translation and translation validation of text in applications and databases.

### BACKGROUND

Applications and databases that are associated with data and user interfaces generally represent data on the user interface or stored in the database in a particular language. When a user that is fluent in a different language uses the application or database, the user may require that the text be translated to that user's language of fluency. Automated or machine-based translation without validation can result in inconsistent or inaccurate results. The machine-generated results may change the meaning of terms (e.g., words) and/or phrases (e.g., combinations of words) of the database or application, and thus require manual validation of the translation results. Validation of each translated term or phrase can be time consuming and costly.

### SUMMARY

This specification describes technologies relating to automated translation of data of systems such as databases and applications. The data processing system and methods described include user interfaces enabling reporting of validated translation results. The user interface can report portions of the data for which translation validation was successful along with a probability of success for a given translated term or phrase (e.g., a text string). When an automated translation validation fails, the data processing system generates an alert or other reporting data requesting manual validation by a user of the respective translation.

The data processing system is configured to perform an automatic translation and validation of a term or phrase. First, a translation index is checked to determine whether the term or phrase to be translated has already been translated and validated. If the term is not included in the translation index, the data processing system invokes a translation service to translate the term or phrase.

The translation service includes an engine for translating a term or phrase from one language to another language. The translation service is configured to translate a given term into a second language to generate first translation data. The first translation data are then translated back to the original language, which is called second translation data. The second translation data is thus in the same language as the original term or phrase of the translation query. The term or phrase of the second translation data is compared to the original, untranslated term or phrase. If the second translation data and original data match, the data processing system considers the translation successfully validated. The original term or phase and translation of the term or phrase (e.g., the first translation data) are sent as response data back to the requesting application or database. The original term or phrase and the first translation data including the translated term or phrase are sent to the translation index to update the index with the validated translation for subsequent translations.

The data processing system is configured to perform a synonym check for terms and phrases in a translation request. The synonym check reviews whether synonyms of the term or phrase have been translated and are included in the translation index.

The data processing system is configured to generate an alert for manual review of a translation if validation is not successful. Validation is not successful when the second translation data (including the re-translated term or phrase back to the original language) does not match the term or phrase included in the original translation request. In this case, the data processing system flags the translation for manual review by a user. The manual review can include a check that updates one or more of the synonym check or translation index, the translation service, or the input of a manual translation. The manual translation is validated by the translation service as previously described. If the validation is not successful, the data processing system maintains the alert (or generates another alert) again requesting manual review.

One or more embodiments of the systems and methods described herein can each optionally enable one or more of the following advantages. The data processing system is configured to translate text of user interfaces for applications and systems as an automated service. The automated validation reduces a number of terms or phrases which require review by a user, and these terms or phrases are automatically highlighted to the user in alerts. The translation index results in a fast and reliable translation result (e.g., with linear computing time). The automatic validation enables automated translation without drifting of meaning across many translation iterations.

In a general aspect, a method includes receiving a translation query specifying a text string, a target language for translating the text string, and an original language of the text string; generating, based on inputting the text string into translation logic of a translation service, first translation data comprising a translated text string in the target language; inputting, into the translation logic of the translation service, the first translation data comprising the translated text string in the target language; generating, based on inputting, second translation data representing translation of the translated text string to the original language from the target language; comparing the second translation data to the translation query; when the translation of the translated text string to the original language from the target language matches the text string of the translation query, validating the first translation data as representing an accurate translation of the text string; and outputting, in response to validating, the first translation data.

In some implementations, the process includes, in response to validating, updating a data index to associate the text string of the translation query to the translated text string in the target language of the first translation data.

In some implementations, the process includes in response to receiving the translation query, searching the data index for a validated translation responsive to the translation query; and when the validated translation responsive to the translation query is in the data index, outputting the validated translation.

In some implementations, the process includes, in response to receiving a second translation query comprising a second text string in the original language for translation to the target language, accessing a data index storing associations between text strings in the original language and respective translated text string in the target language; determining, based on the accessing, that the data index is storing the second text string represented in the second translation query associated with translation data including a second translated text string in the target language; and responsive to determining, providing the second translated text string corresponding to the second text string.

In some implementations, the translation query is a part of a request to provide a translated network resource, and wherein the first translation data is output as a portion of the translated network resource.

In some implementations, the network resource comprises one of a webpage, a form, a document, or an application user interface.

In some implementations, one or more non-transitory computer readable media store instructions for performing the process previously described. In some implementations, a device comprising one or more processors and a memory stores instructions that, when executed, cause the one or more processors to perform the operations of the process previously described.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an environment for data driven translation and translation validation of digital content.

FIG. 2 illustrates an environment for data driven translation and translation validation of digital content.

FIGS. 3A-3B illustrate example data processing systems for data driven translation and translation validation of digital content.

FIG. 3C shows an example of a set of data dictionaries.

FIGS. 4A-4C illustrate example dataflow of a data processing system for data driven translation and translation validation of digital content.

FIG. 4D illustrates an example of generating a response to a translation query by the data processing systems of FIGS. 3A-4C.

FIGS. 5-8 illustrate example processes for data driven translation and translation validation of digital content.

FIGS. 9A-9B show example user interfaces of an application translated by the data processing system of FIGS. 1-4C.

FIG. 10 shows an example user interface.

Like reference numbers and designations in the various drawings indicate like elements.

### DETAILED DESCRIPTION

A data processing system is configured for executing a translation service in response to a translation request from a remote system, such as a client device executing an application or a server hosting a database. The data processing system is configured to generate a translation of text of the application or database (also called remote systems or requesting systems). The translated text need not be presented to users by the requesting system. The data processing system is configured to automatically validate the translations performed to ensure that the translation response is accurate (e.g., 100% accurate). The data processing system is configured to translate text presented in any kind of user interface or back-end system. For example, the data processing system is configured to translate text for user interface controls (e.g., buttons, sliders, fields, drop down menus, etc.). The data processing system is configured to translate labels (field names), content (field values), messages, UI controls, menus, and so forth. In some implementations, the data processing system is configured to translate back-end text to avoid breaking system calls within an application. In some implementations, the data processing system is configured to update a user interface to show translated text on top of an existing application interface without altering the application itself The translations are automatically validated and validated translations are stored for subsequent use in response to subsequent translation queries.

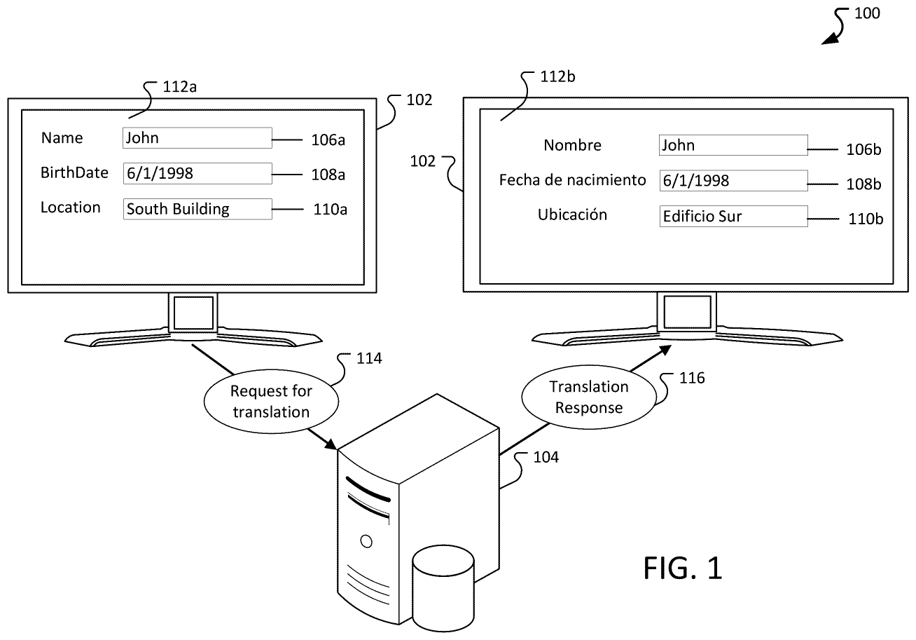

FIG. 1 illustrates an environment 100 for data driven translation and translation validation of digital content. The environment 100 includes a remote system 102 (including user interfaces 112a and 112b). The environment 100 includes a data processing system 104 configured to perform translations of text in in applications, databases, and other programs hosted (e.g., executed by, operated by, etc.) the remote system 102. The data processing system receives a translation request 114 from the remote system 102. The translation request 114 includes data representing the text for translation by the data processing system 104. The translation request 114 can include discrete terms or phrases in individual requests for a particular application or database. In some implementations, the request 114 includes all data to be translated by the data processing system 104 in a single message. In some implementations, the data processing system 104 is configured to receive data representing the user interface of an application or database files of a database and extract text to be translated from the files or the user interface data. In some implementations, the request 114 conforms to an application programming interface (API) associated with the data processing system 104 that identifies the terms or phrases for translation in the application or database.

The data processing system 104 is configured to perform a translation of the terms or phrases specified in the request 114. The data processing system 104 is configured to validate the translation. When a translation is validated, the data processing system 104 sends a translation response 116, including the validated translation, back to the remote system 102.

The remote system 102 updates a user interface or file of the application or database with the data of the translation response 116. User interface 112a shows an original presentation of data of an application hosted by the remote system I 02. The user interface 112a shows three fields: Name I 06a, Birthdate I 08a, and Location 110a, each populated with respective values James, Jun. 1, 1998, and South Building. The terms Name, Birthdate, and Location are translated by the data processing system 104 because they are part of the user interface 112a. The values entered into the fields 106a, 108a, and 110a can be translated or not translated, depending on the settings of the system. For example, in some implementations, the values are not translated because they are not part of the program being translated, but data entered into the application. Additionally, John is a proper noun and is therefore not translated. In some implementations, the values are translated. For example, the value “South Building’ is translated to “Edificio Sur.” The data processing system 104 translates the field names 106a, 108a, and 110a to respective values Nombre 106b, Fecha de nacimiento 108b, and Ubicaci6n 110b. In this case, the target language is Spanish. The target language can be specified in advance of receiving the request 114 or in the request 114 itself The translated values 106b, 108b, and 110b are included in the updated user interface 112b.

As subsequently described, the data processing system 100 includes a translation index (or translation database) storing known translations for terms or phrases. Each term in the translation index is linked or associated with translations to one or more languages. When the data processing system receives a query specifying a translation of a term or phrase in a document, database file, application interface, etc., the translation service is configured to first search the translation index for the term or phrase. If the term or phase is included in the index, the data processing system accesses the associated translation (e.g., of a selected language). The data processing system provides the data representing the translated term or phrase in a response to the translation query. The translation index enables a quick and reliable translation to be performed. Processing load of the data processing system is reduced because each term or phase in the document or database does not need to undergo the translation and validation process. The terms and phrases included in the index are terms and phrases that have already been validated as subsequently described.

When the translation of a term or phrase is not available in the translation index, the data processing system is configured to perform an automatic translation and validation of the term or phrase using a translation service. The translation service includes an engine for translating a term or phrase from one language to another language. The translation service is configured to translate a given term into a second language to generate first translation data.

The first translation data is sent to a broker of the data processing system. The broker is configured to direct data to different processing modules in the data processing system, such as the translation service or the translation index. The broker sends the first translation data back to the translation service to translate the translated term back to the original language, which is called second translation data. The second translation data is thus in the same language as the original term or phrase of the translation query. The term or phrase of the second translation data is compared to the original, untranslated term or phrase. If the second translation data and original data match, the data processing system considers the translation successfully validated. The original term or phase and translation of the term or phrase (e.g., the first translation data) are sent as response data back to the requesting application or database. The original term or phrase and the first translation data including the translated term or phrase are sent to the translation index to update the index with the validated translation for subsequent translations.

The data processing system is configured to perform a synonym check for terms and phrases in a translation request. The synonym check reviews whether synonyms of the term or phrase have been translated and are included in the translation index.

The data processing system is configured to generate an alert for manual review of a translation if validation is not successful. Validation is not successful when the second translation data (including the re-translated term or phrase back to the original language) does not match the term or phrase included in the original translation request. In this case, the data processing system flags the translation for manual review by a user. The manual review can include a check that updates one or more of the synonym check or translation index, the translation service, or the input of a manual translation. The manual translation is validated by the translation service as previously described. If the validation is not successful, the data processing system maintains the alert (or generates another alert) again requesting manual review.

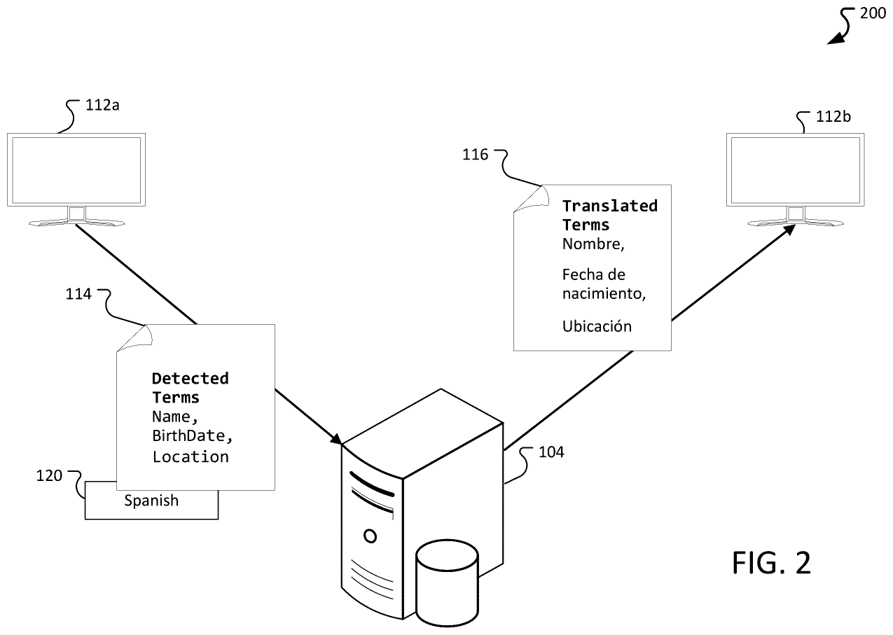

FIG. 2 illustrates an environment 200 for data driven translation and translation validation of digital content by the data processing system 104 of FIG. 1. The environment 200 of FIG. 2 shows additional detail for the request 114 and the response 116 for the translation by the data processing system 104 for the environment 100 of FIG. 1. For example, the request 114 includes a list of terms or phrases for translation. In this example, the terms and phrases are already extracted from the other data of the requesting application or database. For example, request 114 includes detected terms Name, Role, and Birthdate in a list. In some implementations, the remote system 102 sends an entire application file (e.g., of the hosted application) and the data processing system 104 extracts the terms for translation. In this example, the phrases Birthdate and Role are concatenated into single words or terms. The data processing system 104 is configured to determine that these are not single words but concatenated phrases. The data processing system 104 is configured to split the terms into “Birth Date” and “Location,” perform the translation, and respond with the translated terms in a response 116. Validation of the translation includes a determination of which terms are to be split apart into phrases and which terms are not split.

In the example of FIG. 2, the request 114 is appended with data 120 specifying a target language (“Spanish”). This data 120 of request specifies the target language to the data processing system 104 for translating. In some implementations, the data 120 specifying the target language is sent in advance of the request 114 rather than with a request.

The data processing system 104 sends the response 116 including translated terms back to the remote system 102 to update the interface 112b. In this example, the translated terms include Nombre, Fecha de nacimiento, and Ubicaci6n. These translations are validated, as subsequently described, and sent back to the remote system 102 for including in the application or database. In some implementations, the data processing system 104 send a response 116 including updated application files or database tables, and so forth, rather than a simple list of translated words. In this case, the remote system 102 can update the application or database with the translated files.

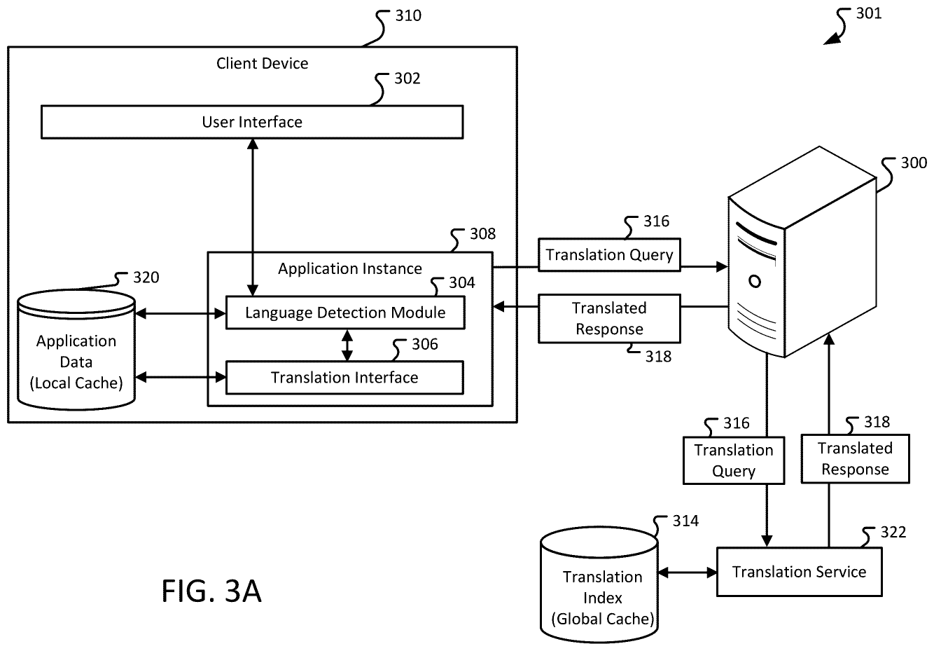

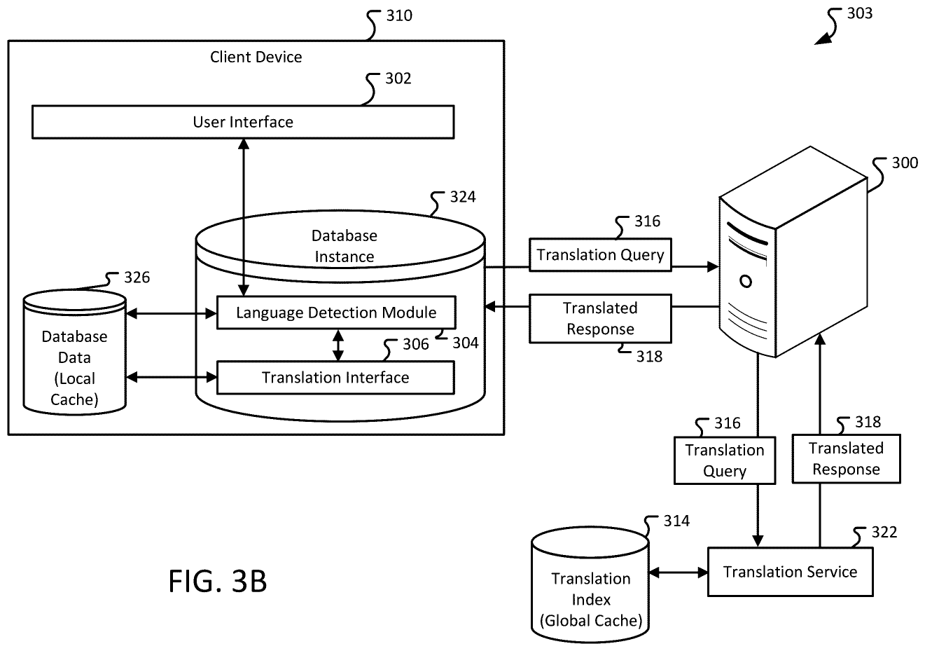

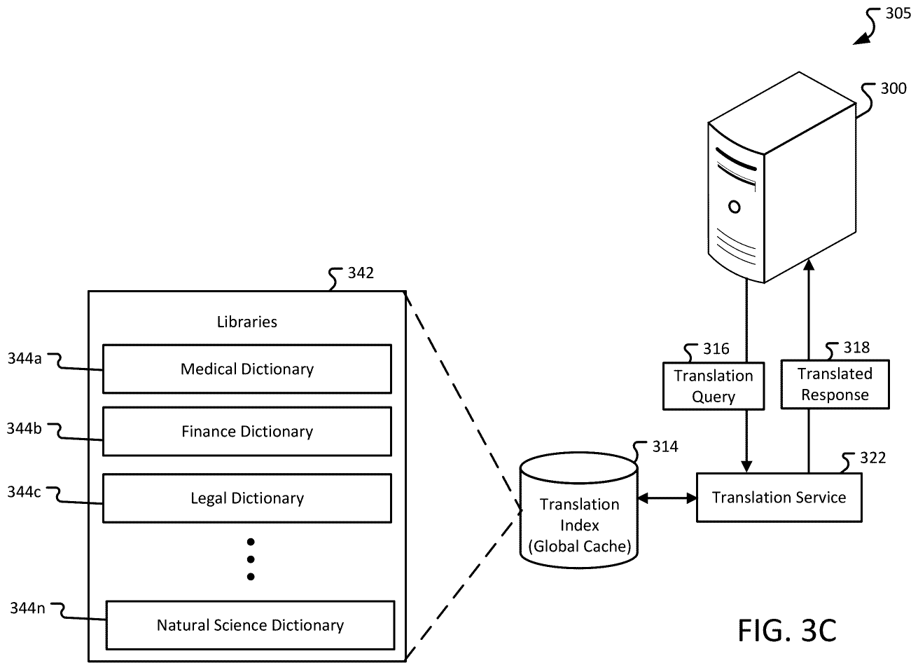

FIGS. 3A-3B illustrate environments 301, 303 including an example data processing system 300 (e.g., similar to data processing system 104 of FIGS. 1-2) for data driven translation and translation validation of digital content. In FIG. 3A, the data processing system 300 can communicate with a client device 310 (e.g., similar to remote system 102 of FIGS. 1-2). The client device 310 hosts an application instance 308. Generally, the client device 310 has a user interface 302 for presenting data associated with the application instance 308. The application instance 308 can include any program with translatable text. For example, an application instance 308 can include a browser, design software, word processor, game program, and so forth.

The application instance 308 includes a language detection module 304 and a translation interface 306. The language detection module 304 is configured to determine an original language of the application instance 308 and specify a target language for translation of the application instance 308 data (e.g., for presentation on the user interface 302). The language detection module 304 is configured to access application database 320 (e.g., local cache) including application files (e.g., files at the presentation layer, such as those presenting fields, controls, etc.). The language detection module 304 can determine a language of the application from the application data 320 including metadata associated with the application specifying the language. In some implementations, the language detection module is configured to automatically detect a language by parsing text of the application instance 308. The language detection module 304 can receive data specifying a target language for translation.

The translation interface 306 is configured to configure a translation query 316 (e.g., similar to request 114 of FIG. 1). The translation interface 306 can generate requests based on an API of the data processing system 300. In some implementations, the request includes application files for being translated (e.g., retrieved from application data store 320) along with a specification of an original and target language. The query 316 is received by the data processing system 300 from the client device 310. In some implementations, the request includes a document object model (DOM) of the target. In some implementations, a parse determines the fields, field values, and other translatable text on the GUI for sending to the data processing system in the translation request.

The data processing system 300 is configured to invoke the translation service 322 configured to perform a translation from the original language to the target language. As previously described, the data processing system 300 translates the text of the received application data 320 and validates the translation. The data processing system 300 includes a translation index 314 (e.g., a global cache) included terms and phrases associated with validated translations to one or more other languages. The data processing system 300, in response to receiving the query 316, searches the index 314 for the term or phrase and its associated translation into the target language. If the term is included in the translation index 314, the result is retrieved and sent in the translation response 318. If the term or phrase is not already included in the index 314, the translation service 322 performs a translation, validates the translation (as subsequently described), and sends the validated translation in the translation response data 318.

FIG. 3B shows an environment 303 including the data processing system 300 and a client device 310 (e.g., similar to environment 301 of FIG. 3A). The client device 310 hosts a database instance 324. Generally, the client device 310 has a user interface 302 for presenting data associated with the database instance 324.

The database instance 324 can include any database storing translatable text. For example, the database instance 324 can include a hierarchical database, a network database, an object-oriented database, a relational database, a non-relational database, and so forth, each storing files, tables, forms, graphs, and so forth. The database instance 324 includes or is associated with a software layer for operation of the database. The database instance 324 includes or is associated with a language detection module 304 and a translation interface 306. The language detection module 304 is configured to determine an original language of data stored in the database instance 324 and specify a target language for translation of the database instance 324 data (e.g., for presentation on the user interface 302). The language detection module 304 is configured to access database data 326 (e.g., a local cache) including database files such as forms, graphs, tables, schema data, and so forth. The language detection module 304 can determine a language of the application from the database data 326 including metadata associated with the database specifying the language. In some implementations, the language detection module 304 is configured to automatically detect a language by parsing text of the database instance 324. The language detection module 304 can receive data specifying a target language for translation.

FIG. 3C shows an example of an environment 305 the data processing system 300 and the translation index 314. (e.g., similar to environment 301 of FIG. 3A and environment 303 of FIG. 3B). The data processing system 300 is configured to send the translation query 316 to the translation service 322 and receive the translated response 318 as previously described. The translation service 322 can include a set of libraries 342 (also called data dictionaries) for providing the translated response 318. Generally, when performing translations, the source of the lexigraphy or a connotative context in which the translation is being performed can be relevant to producing an accurate translation. For example, a given term could have a first meaning in a first context and a very different meaning in a second, different context. In either context, a word with a common definition known in a general sense may have a particular meaning or may be a term of art in either the first or second contexts. For example, the phrase “script” in a computing context may indicate a meaning of “set of computer executable instructions.” However, in an entertainment context, a “script” can refer to a screenplay. When translated, the meaning may be different for languages that do not have a homonym for the same two meanings. In another example, a “pen” can refer to, in an agricultural context, a “holding area for livestock.” However, in an office context, a “pen” likely refers to writing instrument using ink.

To improve the translation response 318, the data processing system 300 is configured to detect the context for which the translation is being performed. In some implementations, the data processing system 300 detects the context based on identifying key terms or key phrases and applying a fingerprinting test these key terms or key phrases. The fingerprinting test refers to a process in which a collection of the terms or phrases are compared to known lists of terms or phases. each list corresponding to a list of terms for a particular, known context such as medical terms, legal terms, business terms, computing terms, natural science terms, finance terms, and so forth. When there are enough matches, the data processing system 300 determines that the context of the translation is that of the matching list. In some implementations, the context is explicitly specified by a user or in the target document.

When a context is detected or specified, the data processing system 300 accesses a dictionary 344 (e.g., one of dictionaries 344a-n) for performing the translation. The dictionary provides particular definitions or terms as responses for translation and information about the relationships between or among terms. In some implementations, once the dictionary 344a-n is identified, the data processing system 300 is configured to build the dictionary with new terms that are received in the translation queries that are not already translated. The data processing system 300 can build the data dictionaries either automatically or semi-automatically (e.g., using synonym engines and validation by a user). In some implementations, the data processing system 300 builds the selected dictionary after a user validates proposed translations of novel terms in translation queries or after the user manually translates these novel terms. The validated translation of the novel term is added (e.g., appended) to the existing dictionary and thereafter is translatable for particular context specified by that dictionary. The data processing system 300 is thus configured to build context-specific dictionaries.

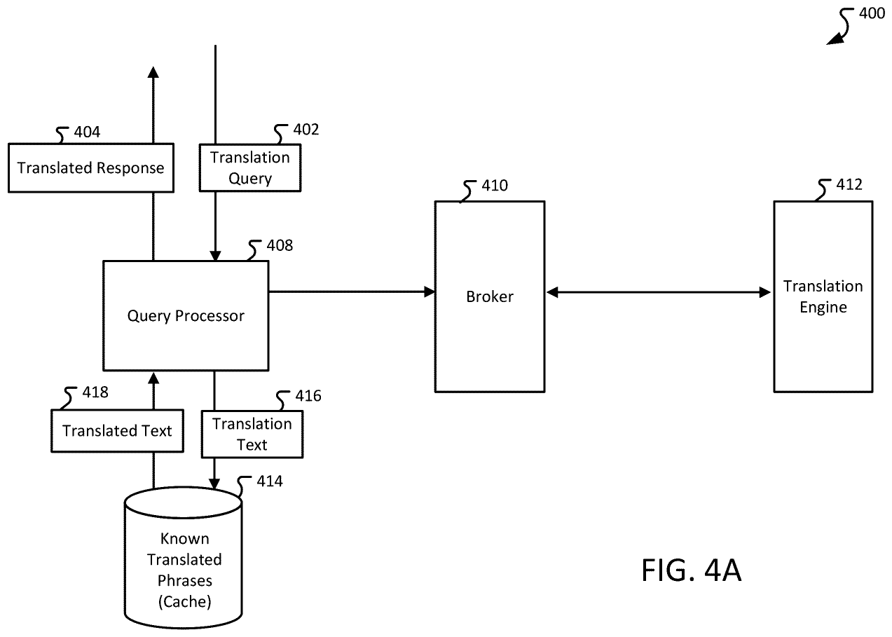

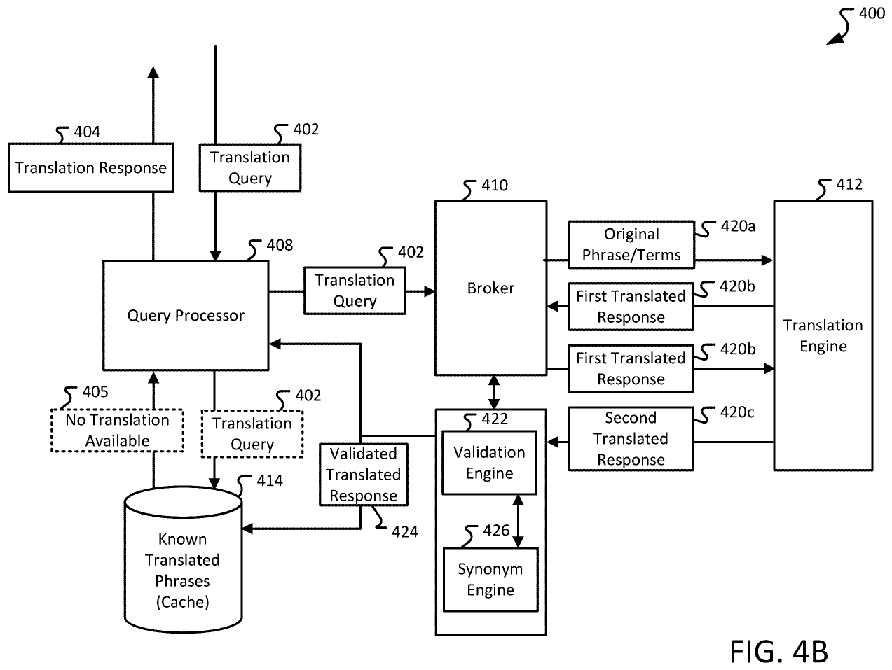

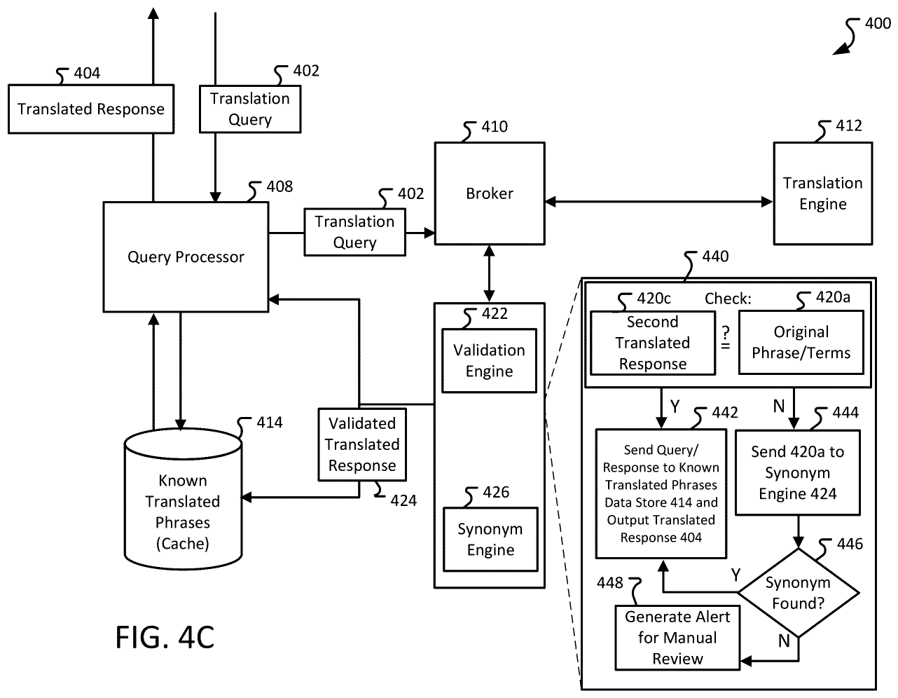

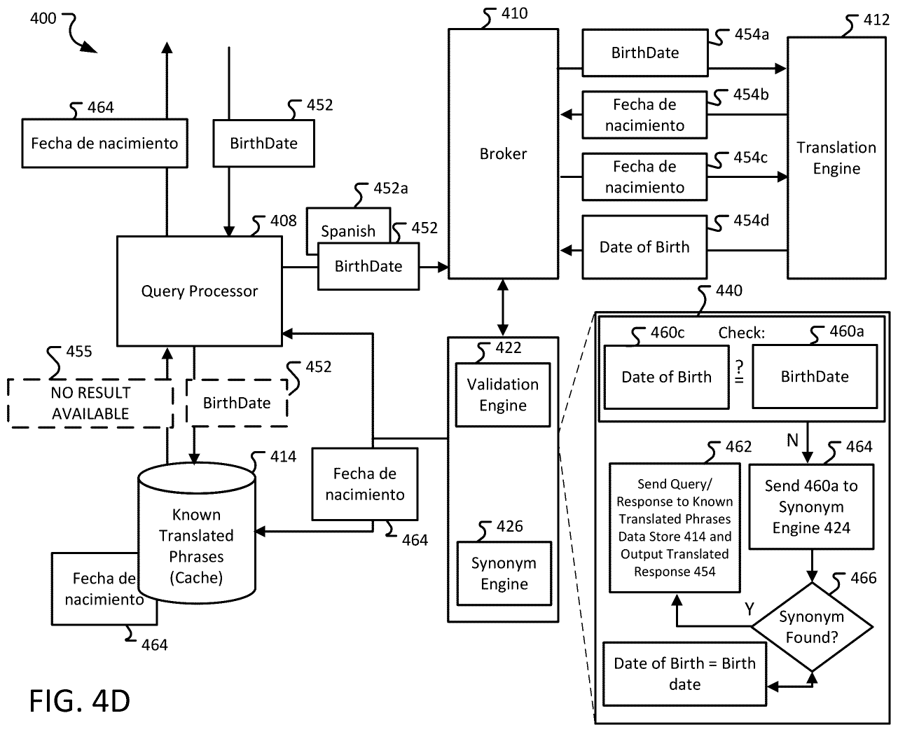

FIGS. 4A-4C illustrate example dataflow of a data processing system 400 (e.g., similar to data processing systems 104, 300 of FIGS. 1-3B) for data driven translation and translation validation of digital content, such text of database or application instances on a client device. The data processing system 400 includes a query processor 408 configured to receive queries from remote devices (e.g., client device 310 of FIGS. 3A-3B). The query processor 408 is configured to receive a translation query 402. The translation query specifies a target language, an original language, and provides data to be translated by the data processing system 400. In some implementations, if the original and/or target languages are not specified in the translation query 402, the query processor 408 determines the original language and target language from other data sources. The other data sources can include a previously specified target language (e.g., received from the client device). The other data sources can include metadata associate with the files to be translated. In some implementations, the query processor 408 is configured to scan the received files of the query 402 and determine the language of text in the files.

The query processor 408 is configured translation text 416 including terms and phrases to a translation index 414 including known translated phrases, as previously described. The index 414 can include terms and phrases linked to translation targets for one or more languages for which a validated translation has occurred. The index is built over time as more translation phrases and terms are added in response to translation at the translation engine 412. Each time a validated translation is performed, the result and original text are included as associated data (e.g., key-foreign key pairs) in the index 414. The index retrieves the translated text 418 associated with the original phrase or term. The translated text 418 are sent back to the query processor 408. Because all phrases and terms and their associated translations stored in index 414 have already been validated, there is no requirement to re-validate these translations.

The query processor 408 generates translation response data 404 including the translated text 418. In some implementations, the query processor 408 simply forwards the translated text 418 as is to the client device as the response 404. In some implementations, the query processor 408 embeds the translated text in application files or database files including the same format as those received in the query 402 if such application or database files were included in the query. In some implementations, the query processor 408 generates a series of formatted responses 404 each included a distinct validated term or phrase translation.

The query processor 408 can send all or part of the translated files back to the client device in the response 404. For example, if the translated text is only partially validated, the query processor 408 may return those validated translated portions of text to the client device. The query processor 404 waits until validation occurs for the remaining terms or phrases before sending respective translated text to the client device for those terms or phrases. In some implementations, the query processor 408 does not send a response 404 until all data associated with the query 402 are successfully translated and validated.

The query processor 408 receives a response from the index 414 including either translated text 418 or a null response indicated that the term or phrase is not present in the index 414. When the term or phrase is not included in the index 414, the query processor 408 sends the query to a broker 410 for managing the translation and validation process, subsequently described, of the translation engine 412.

FIG. 4B shows dataflow for the data processing system 400 of FIG. 4A once the index 414 is accessed by the query processor 408 and no translation is found, as shown by response 405. The query processor 408 sends the translation query 402 (or text for translation in the translation query 402) to a broker 410. The broker 410 includes a processing module configured to manage dataflow in the data processing system 400. The broker 410 is configured to send data to and from a translation engine 412. The broker 410 is configured to send data to and receive data from a validation engine 422 and synonym engine 424 that process data during the translation and validation processes.

The translation engine 412 is configured to actually translate text from a first language to a second language. The translation engine 412 receives an input of a given language and a target language and simply performs a translation of the term or phrase to the target language from the original language. The translation engine 412 can include one or more translation applications or services. In some implementations, the translation service can be selected from a list of available translation services.

The broker receives the translation query 402 and sends the text of the translation query 420a to the translation engine 412 for translating the text to the target language. The translation query 420a includes the original terms and phrases to be translated into the target language. The translation engine 412 performs a first translation of the query 420a into the target language for a first translated response 420b. The first translated response 420b is then validated.

To validate the first translated response 420b, the broker 410 sends the first translated response back to the translation engine 412. The translation engine 412 translates the response 420b from the target language back to the original language. This second translation is included in a second translated response 420c that is output by the translation engine 412.

A validation engine 422 validates the first translation response 420b by comparing the second translation response 420c to the original query 420a. If the validation engine 422 determines that a match is found between the original query 420a and the second translation response 420c, both of which are in the original language, the first translated response 420b is determined to be accurate and is marked as validated. The validated translation response 424 (including the first translation response 420b) is sent to the index 414 to update the index as previously described. Additionally, the translation response 424 is sent to the query processor 408. The query processor 408 embeds the validated translation response 424 into the application or database files (if applicable) and sends a translation response 404 back to the client device including the translated files.

In some implementations, a synonym engine 426 is referenced if no match is found by the validation engine 422. For example, the translation may be accurate for a synonym of the original term or phrase. If a suitable synonym is found for the translation, the result is included in the translation response 424, and the index 414 is updated.

FIG. 4C shows dataflow for the data processing system 400 of FIG. 4B representing a process for validation of the translation 420c by validation engine 422. The validation engine 422 checks (440) the second translated response 420c for a match with the original term/phrases of query 402. If a match is found, as previously described, the validation engine 422 sends (442) (e.g., through broker 420) the validated response 424 including the first translation 420b to the known translated phrases data store 414. The broker 410 also sends the validated response 424 to the query processor 408 for being output in the response 404 in application or database files.

If the second translated response 420c and the original terms/phrases 420a do not match, the validation is not successful. The validation engine 422 sends (442) the terms/phrase data 420a and translation response 420b to a synonym engine 446 for comparing the translation to those of synonyms of the original term/phrase. If a matching synonym is found (446), the broker identifies the translation of the synonym and the original term/phrase as a validated translation and updates the index 414. If no matching synonym is found, the validation engine generates (448) an alert requesting manual review of the translation.

The alert can be presented on a user interface of the data processing system 400. The alert identifies terms/phrases that were not successfully validated. A representation of the original term and suggested translation(s) can be presented to a user. The user can validate the translation, suggest an alternative translation, or perform some other corrective action.

FIG. 4D shows an example data processing system 400 from FIGS. 4A-4C, including an example translation query of “birthdate.” The term “birthdate” is received by the query processor 408 as translation query 452. The query processor, as previously described, parses the term from the page or request to determine that the term “Birthdate” 452 is being translated.

The query processor 408 first checks the cache 414 of known phrases. The query processor, in this example, finds that no result is available in cache response 455. The query processor 408 then proceeds to request a translation of the query 452 from the translation service using reverse translation as previously described.

The query processor 408 sends the term “birthdate” to the broker 410 for translation using the translation engine 412 (e.g., a translation service). The query processor 408 determines that the target language 452a is Spanish. As previously described, translation engine 412 can include a 3rd party translation service. The query “birthdate” is sent to the engine 412 as a first translation request 454a. The translation engine 412 returns the translation result 454b specifying “Fecha de nacimiento.” This result 454b is sent back to the translation engine 412 as a second translation request 454c. The translation engine 412 reverse translates this request to a final translation 454d specifying “date of birth.”

To validate the translation 454b “fecha de nacimiento,” the data processing system sends the result 454d “date of birth” to the validation engine 422. The validation engine 422 compares (440) the result 454d “date of birth” to the original request 454a “Birthdate.” The validation engine determines that this is not an exact match, and thus sends (464) the result 454d “Date of Birth” to a synonym engine 426. The synonym engine 426 checks to determine whether the result is similar or a synonym. In this example, the synonym 426 determines (either automatically or after soliciting manual review) that the phrase “Date of Birth” is a suitable reverse translation of the original term “Birthdate.” Therefore, the translation 454b “fecha de nacimiento,” is validated as an acceptable translation response 464 for “Birthdate.” The result 454b is sent to be stored in the cache 414 to build the global translation cache with the translation response 464. The validated translation response 464 is sent to the client.

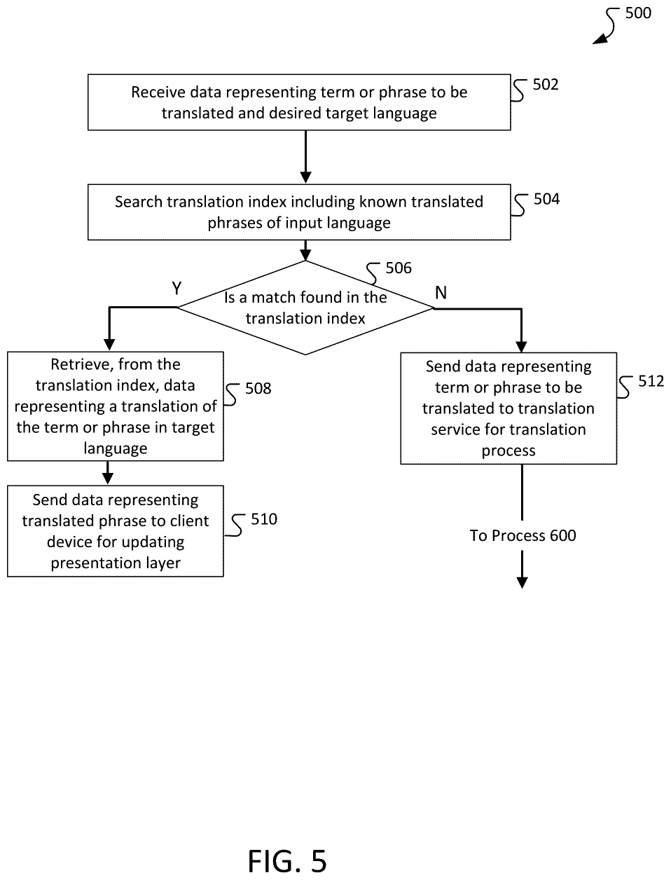

FIGS. 5-8 illustrate example processes 500, 600, 700, and 800 for data driven translation and translation validation of digital content. FIG. 5 shows a process 500 by which a data processing system (e.g., data processing system 104, 300, 400, etc.) checks an index (e.g., index 314 or index 414 previously described) to determine whether a term or phrase already is associated with a validated translation. The data processing system is configured to receive (502) data representing term or phrase to be translated and desired target language. The data processing system performs a search (504) of the translation index including known translated phrases of input language. The data processing system determines (506) if a match found in the translation index. If a match is found, the data processing system retrieves (508), from the translation index, data representing a translation of the term or phrase in target language. The data processing system sends (510) the data representing translated phrase to client device for updating presentation layer (e.g., user interface 302 of client device). If the data processing system determines that no match is found, the data processing system sends (512) data representing the term or phrase to be translated to translation service for translation process 600.

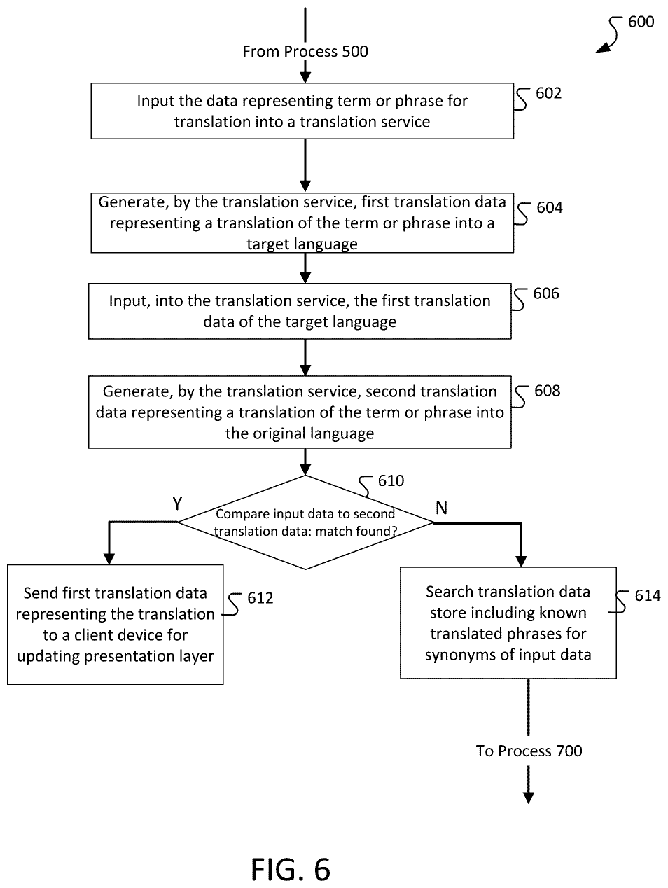

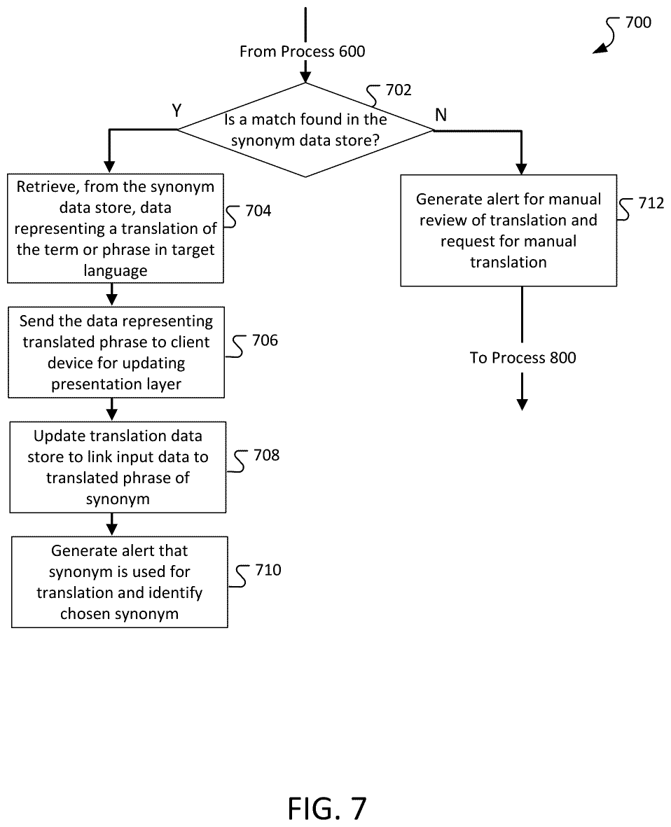

FIG. 6 shows a process 600 by which a data processing system (e.g., data processing system 104, 300, 400, etc.) performs translation and validation of a term or phrase when the term or phrase is not included in the translation index. The data processing system is configured to input (602) the data representing term or phrase for translation into a translation service. The data processing system is configured to generate (604), by the translation service, first translation data representing a translation of the term or phrase into a target language. The data processing system is configured to input (606), into the translation service, the first translation data of the target language. The data processing system is configured to generate (608), by the translation service, second translation data representing a translation of the term or phrase into the original language. The data processing system compares (610) input data to second translation data. If the data processing system finds a match, the data processing system sends (612) first translation data representing the translation to a client device for updating presentation layer. If the data processing system does not find a match, the data processing system performs a search (614) of the translation data store including known translated phrases for synonyms of input data. The process proceeds to process 700 of FIG. 7 to perform a synonym check.

FIG. 7 shows a process 700 by which a data processing system (e.g., data processing system 104, 300, 400, etc.) checks a synonym data store. The data processing system is configured to determine (702) whether there is a synonym match found in the synonym data store. A synonym match indicates that a synonym of the term or phrase has been translated and is associated with a validated translation. If a match is found the data processing system is configured to retrieve (703), from the synonym data store, data representing a translation of the term or phrase in target language. The data processing system sends (706) the data representing translated phrase to client device for updating presentation layer. The data processing system updates (708) the translation data store to link input data to translated phrase of synonym. The data processing system generates (710) alert that synonym is used for translation and identify chosen synonym.

If no match is found in the synonym data store, the data processing system generates (712) an alert for manual review of translation and request for manual translation, and proceeds to process 800.

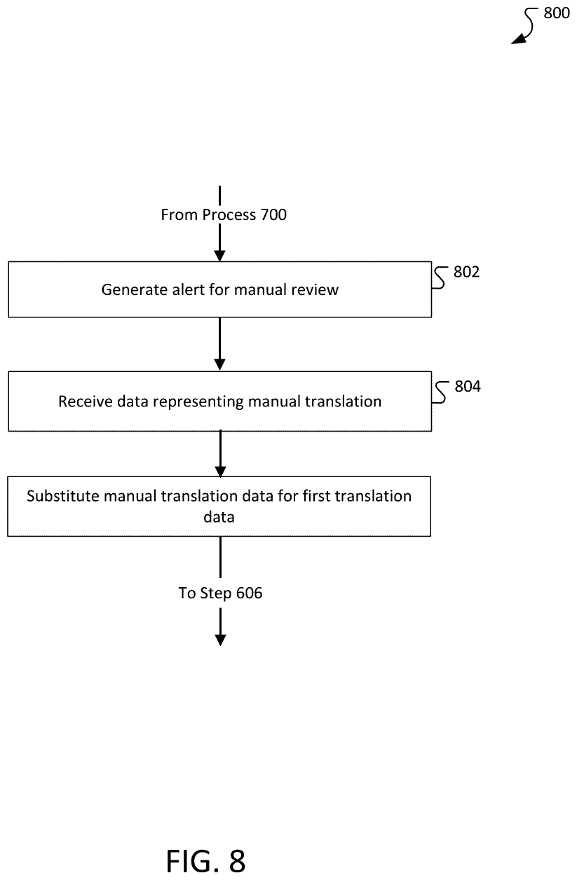

FIG. 8 shows a process 800 by which a data processing system (e.g., data processing system 104, 300, 400, etc.) generates alerts for manual review of a translation that is not validated. The data processing system generates (802) an alert for manual review of the term or phrase. The data processing system receives (804) data representing manual translation. In some implementations, the data are received through a user interface associated with the data processing system. The data processing system substitutes (806) the manual translation data for first translation data. The data processing system then performs a validation of the proposed translation by the user (see process 600). The process repeats until a validated translation is found.

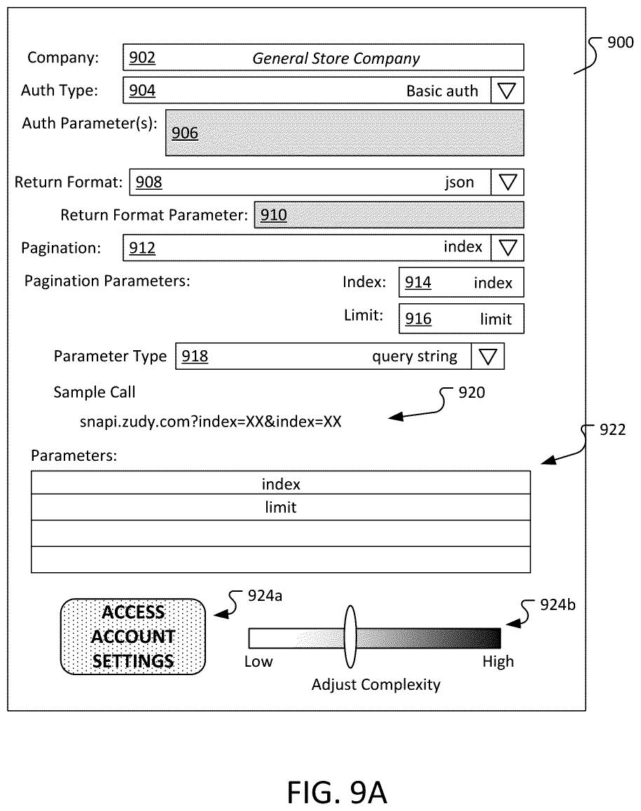

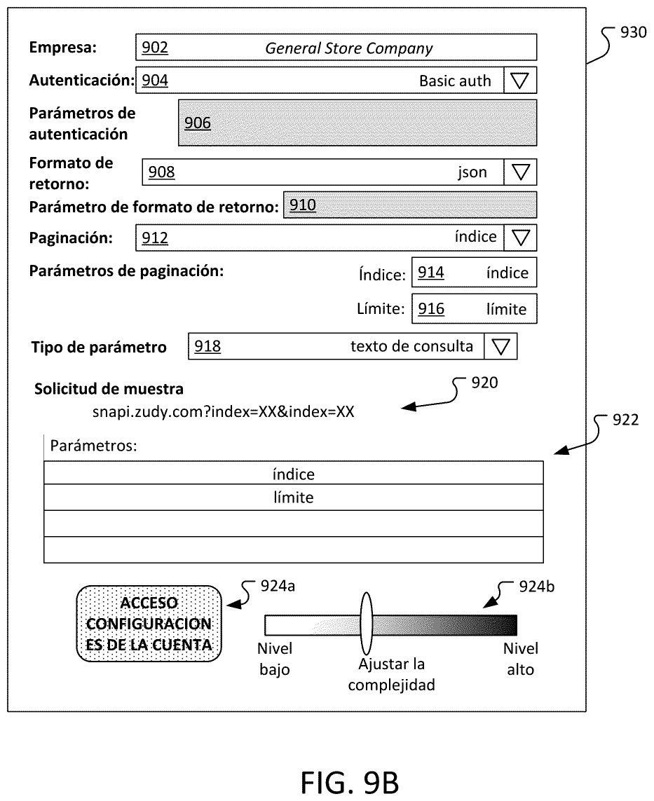

FIGS. 9A-9B illustrate examples of a user interface 900 that is translated by the data processing system (e.g., data processing systems 104, 300, 400, etc.). In FIG. 9A, a company field 902 identifies the name of the company. The company 902 field may be prefilled based other information provided by the user. For example, a user's login information may be associated with a particular company. In some implementations, the company field 902 may be specified by a user as part of a registration process.

An authentication type field 904 allows the user to select between a predetermined number of options (for example, using a drop down list). In some implementations, the user can select from a list including for example, Basic authentication, API key authentication, OAuth, or none. In some implementations, the system may require that the organization be associated with some authentication method (for example, none may not be a valid option.)

The authentication parameters field 906 allows the user to specify parameters based on the type of authentication selected in the authentication type field. In this example, the user has selected Basic authentication. As Basic authentication uses predefined entries in an HTTP header, the authentication parameters field 906 is disabled. If the user had, instead, for example, selected the API key authentication, the user would be able to specify the name of the parameter to include the API key.

The user interface 900 can also allow the user to specify the return format 910 of the RESTful service. As described above, the return format may be either JSON or XML. In this example, the user can select from a drop down list (for example, JSON, XML, query based, path based). In this example, the user has selected to receive JSON responses. Accordingly, the return format parameter 910 field is disabled.

The user interface 900 includes a pagination field 912 where the user can specify how results are paginated. In this example, the user may select from a drop down list that includes the valid options (for example, page, index, none). Here, the user has selected “index.” The user can also specify the name of the pagination parameters. The pagination parameters may include the names of variables that will include the index 914 and the limit 914 values.

The user interface 900 also includes a parameter type field 918 that enables the user to define whether parameters are included in the query string, a path, an http header, or a combination thereof. In this example, the user has selected query string parameters.

The user interface 900 also includes a parameter area 922 for presenting parameters defined in the user interface 900. In this example, the index and limit parameters appear (defined in the pagination parameters area, described above). The user may also sort the parameters, for example, by dragging and dropping a field. This enables the user to specify an ordering of parameters for services where the ordering is of interest.

The user interface 900 also includes a sample call 920. The sample call is a visual representation of what a call to an API component. It allows the user to check their data against the API.

The user interface 900 can include one or more controls 924, such as control 924a and control 924b. Controls 924 can include buttons sliders, switches, menus, or any other interactive object in the user interface 900. In the user interface 900, control 924a includes a button and control 924b includes a slider. Text of control 924a specifies that the user can “access account settings.” This may take the user to another user interface in the application or website, etc. The slider 924b specifies a slider to “adjust complexity” between a “low” level and a “high” level. As described previously, the data processing system is configured to discover and translate the term “access account settings,” of control 924a and terms “adjust complexity,” “high,” and “low” for control 924b responsive to when a translation of user interface 900 is requested by a client device.

FIG. 9B shows a translated user interface 930. In the translated user interface, the field names for fields 902, 904, 906, 908, 910, 912, 914, 916, 918, 920, and the data of parameter area 922 are translated from English to Spanish. However, some terms have not been translated. For example, the company name “General Store Company” is not translated because it is a proper name. Additionally, technical terms like JSON are not translated either because they are proper words (e.g., trademarked terms), because they include acronyms, or because they include technical information that is untranslatable.

Specifically, the text of control 924a is translated to “acceso configuraciones de la cuenta.” Text associated with the slider 924b is translated “ajustar 1a complejidad,” “nivel bajo,” representing a “low” level, and “nivel alto,” representing a “high” level. The phase “nivel bajo” is used to represent “high” of the translated user interface 930. This is because simply using the Spanish word “alto” for “high” and the Spanish word “bajo” for “low” may misrepresent the connotation that a relative high or low level is being set by the slider 924b. Therefore, the word “nivel” (level) is added to the Spanish translation to provide an accurate translation.

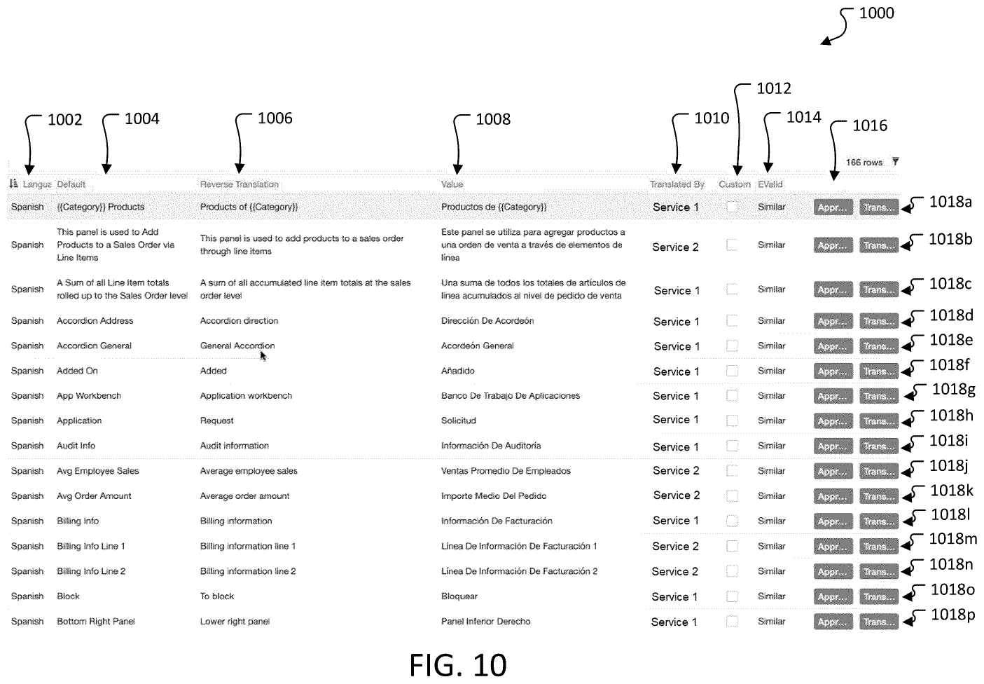

FIG. 10 represents a user interface 1000 of the translation service. The user interface 100 includes rows 1018a-p and columns 1002, 1004, 1006, 1008, 1010, 1012, 1014, and 1016. The rows 1018a-p each represent a term or phrase for translation in a translation request, as previously described. Column 1002 shows which language is requested (e.g., Spanish). The language can be a single language or a set of multiple languages. Column 1004 shows the default term that can represent the input term for translation. The column 1006 represents the results for the reverse translation, as previously described. This includes the translation of the translated term or phrase back into the original language. Column 1008 shows the translation value in the specified language from column 1002. Column 1010 shows the translation service being used (e.g., Google Translate or another service). Column 1012 shows a toggle for specifying a custom result or a default result. Column 1014 shows a similarity of the reverse translation of column 1006 to the default translation of column 1004. The validation column 1014 can report a match (exact match), similar match, or non-match. Column 1016 shows controls for approving or rejecting the proposal or specifying a custom translation. For example, in row 1018n, the data processing system receives a translation request for the phrase “billing info line 2,” shown in column 1002. As shown in column 1010, this is translated by service 2. The reverse translation shown in column 1006 is “billing information line 2.” This is similar, as specified in column 1014, to the default value “billing info line 2” of column 1002. However, the word “info” of the phrase is replaced with “information.” Because the word “information” is a correct translation of the term “info” in this context, the result can be approved using control of column 1016.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs (i.e., one or more modules of computer program instructions, encoded on computer storage mediums for execution by, or to control the operation of, data processing apparatus). A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices). The computer storage medium can be non-transitory.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example, a programmable processor, a computer, a system on a chip, or multiple ones, or combinations, of the foregoing. The apparatus can include special purpose logic circuitry (e.g., an FPGA (field programmable gate array) or an ASIC (application-specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural or object-oriented or functional languages, and it can be deployed in any form, including as a stand-alone program or as a module, component, subroutine, service, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry (e.g., an FPGA (field programmable gate array) or an ASIC (application-specific integrated circuit)).

Processors suitable for the execution of a computer program include, by way of example, both general and special purpose microprocessors, and any one or more processors of any kind of digital, analog or quantum computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive, data from or transfer data to, or both, one or more mass storage devices for storing data (e.g., electronic, magnetic, magneto-optical disks, or optical disks), however, a computer need not have such devices. Moreover, a computer can be embedded in another device (e.g., a mobile telephone, a personal digital assistant (PDA), a mobile audio or video player, a game console, a GPS receiver, or a portable storage device (e.g., a universal serial bus (USB) flash drive)), to name just a few. Devices suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback) and input from the user can be received in any form, including acoustic, speech, or tactile input. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back-end component (e.g., as a data server), a middleware component (e.g., an application server), or a front-end component (e.g., a user computer having a graphical user interface or a Web browser through which a user can interact with an implementation of the subject matter described in this specification), or any combination of one or more such back-end, middleware, or front-end components. The components of the system can be interconnected by any form or medium of digital or optical data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Data fields can have data quality errors in which a value of the data field fails to satisfy one or more standards for the values of that data field. Once a data quality error is identified, it can be difficult to determine how to correct the data quality error without analysis of context of the data quality error.

What is claimed is:

1. A method comprising:
receiving a translation query specifying a text string, a target language for translating the text string, and an original language of the text string;
generating, based on inputting the text string into translation logic of a translation service, first translation data comprising a translated text string in the target language;
inputting, into the translation logic of the translation service, the first translation data comprising the translated text string in the target language;
generating, based on inputting, second translation data representing translation of the translated text string to the original language from the target language;
comparing the second translation data to the translation query;
when the translation of the translated text string to the original language from the target language matches the text string of the translation query, validating the first translation data as representing an accurate translation of the text string; and
outputting, in response to validating, the first translation data.

2. The method of claim 1, further comprising:
in response to validating, updating a data index to associate the text string of the translation query to the translated text string in the target language of the first translation data.

3. The method of claim 2, further comprising:
in response to receiving the translation query, searching the data index for a validated translation responsive to the translation query; and
when the validated translation responsive to the translation query is in the data index, outputting the validated translation.

4. The method of claim 1, further comprising:
in response to receiving a second translation query comprising a second text string in the original language for translation to the target language, accessing a data index storing associations between text strings in the original language and respective translated text string in the target language;
determining, based on the accessing, that the data index is storing the second text string represented in the second translation query associated with translation data including a second translated text string in the target language; and
responsive to determining, providing the second translated text string corresponding to the second text string.

5. The method of claim 1, wherein the translation query is a part of a request to provide a translated network resource, and wherein the first translation data is output as a portion of the translated network resource.

6. The method of claim 5, wherein the network resource comprises one of a webpage, a form, a document, or an application user interface.

7. A device comprising:
one or more processors; and
a memory storing instructions that, when executed by the one or more processors, cause the one or more processors to perform operations comprising:
receiving a translation query specifying a text string, a target language for translating the text string, and an original language of the text string;
generating, based on inputting the text string into translation logic of a translation service, first translation data comprising a translated text string in the target language;
inputting, into the translation logic of the translation service, the first translation data comprising the translated text string in the target language;
generating, based on inputting, second translation data representing translation of the translated text string to the original language from the target language;
comparing the second translation data to the translation query;
when the translation of the translated text string to the original language from the target language matches the text string of the translation query, validating the first translation data as representing an accurate translation of the text string; and
outputting, in response to validating, the first translation data.

8. The device of claim 7, the operations further comprising:
in response to validating, updating a data index to associate the text string of the translation query to the translated text string in the target language of the first translation data.

9. The device of claim 8, the operations further comprising:
in response to receiving the translation query, searching the data index for a validated translation responsive to the translation query; and
when the validated translation responsive to the translation query is in the data index, outputting the validated translation.

10. The device of claim 7, the operations further comprising:
in response to receiving a second translation query comprising a second text string in the original language for translation to the target language, accessing a data index storing associations between text strings in the original language and respective translated text string in the target language;
determining, based on the accessing, that the data index is storing the second text string represented in the second translation query associated with translation data including a second translated text string in the target language; and
responsive to determining, providing the second translated text string corresponding to the second text string.

11. The device of claim 7, wherein the translation query is a part of a request to provide a translated network resource, and wherein the first translation data is output as a portion of the translated network resource.

12. The device of claim 11, wherein the network resource comprises one of a webpage, a form, a document, or an application user interface.

13. One or more non-transitory computer readable media storing instructions that, when executed by one or more processors, cause the one or more processors to perform operations comprising:
receiving a translation query specifying a text string, a target language for translating the text string, and an original language of the text string;
generating, based on inputting the text string into translation logic of a translation service, first translation data comprising a translated text string in the target language;
inputting, into the translation logic of the translation service, the first translation data comprising the translated text string in the target language;
generating, based on inputting, second translation data representing translation of the translated text string to the original language from the target language;
comparing the second translation data to the translation query;
when the translation of the translated text string to the original language from the target language matches the text string of the translation query, validating the first translation data as representing an accurate translation of the text string; and
outputting, in response to validating, the first translation data.

14. The one or more non-transitory computer readable media of claim 13, the operations further comprising:
in response to validating, updating a data index to associate the text string of the translation query to the translated text string in the target language of the first translation data.

15. The one or more non-transitory computer readable media of claim 14, the operations further comprising:
in response to receiving the translation query, searching the data index for a validated translation responsive to the translation query; and
when the validated translation responsive to the translation query is in the data index, outputting the validated translation.

16. The one or more non-transitory computer readable media of claim 13, the operations further comprising:
in response to receiving a second translation query comprising a second text string in the original language for translation to the target language, accessing a data index storing associations between text strings in the original language and respective translated text string in the target language;
determining, based on the accessing, that the data index is storing the second text string represented in the second translation query associated with translation data including a second translated text string in the target language; and
responsive to determining, providing the second translated text string corresponding to the second text string.

17. The one or more non-transitory computer readable media of claim 13, wherein the translation query is a part of a request to provide a translated network resource, and wherein the first translation data is output as a portion of the translated network resource.

18. The one or more non-transitory computer readable media of claim 17, wherein the network resource comprises one of a webpage, a form, a document, or an application user interface.
